(19) United States
(12) Patent Application Publication
(10) Pub. No.: US 2015/0323040 A1
(43) Pub. Date: Nov. 12, 2015

(54) CLOSED DAMPER HUB

(71) Applicant: Schaeffler Technologies AG & Co. KG, Herzogenaurach (DE)

(72) Inventors: Daniel Patiño Crespo, Puebla (MX); Raymundo Juan Lien Chang, San Pedro Cholula (MX)

(21) Appl. No.: 14/700,350

(22) Filed: Apr. 30, 2015

Related U.S. Application Data
(60) Provisional application No. 61/989,964, filed on May 7, 2014.

(51) Int. Cl. F16F 15/131; F16F 15/134

(52) U.S. Cl. CPC F16F 15/13164; F16F 15/134; F16F 15/13142

(57) ABSTRACT

A damper hub assembly for a marine vessel propulsion unit is provided. The damper hub assembly includes a damper hub having an inner circumferential surface and a disc held at the inner circumferential surface. A drive assembly for a marine vessel propulsion unit is also provided that includes the damper hub assembly, a damper on an outer surface of the damper hub and a flywheel fixed to the damper configured for transferring torque from an engine to the damper hub via the damper. A method for forming damper hub assembly for a marine vessel propulsion unit is also provided that includes securing a disc to an inner circumferential surface of a damper hub at an engine side of the damper hub.

This claims the benefit to U.S. Provisional Patent Application No. 61/989,964, filed on May 7, 2014, which is hereby incorporated by reference herein.

The present disclosure relates generally to damper hubs and more specifically to damper hubs for marine vessel propulsion units.

### BACKGROUND

U.S. Publication No. 2014/0083241 discloses a flywheel assembly for a marine vessel propulsion unit including a damper hub.

### SUMMARY OF THE INVENTION

In damper hubs for marine vessel propulsion units, humidity may affect properties of grease used to lubricate contact between the damper and a transmission input shaft and the grease may flow out of the damper hub and contaminate the transmission system. Providing a damper hub with a disc shaped cap of the present disclosure may minimize the effects of the humidity on the grease and may prevent the grease from escaping from the hub.

A damper hub assembly for a marine vessel propulsion unit is provided. The damper hub assembly includes a damper hub having an inner circumferential surface and a disc held at the inner circumferential surface.

A drive assembly for a marine vessel propulsion unit is also provided that includes the damper hub assembly, a damper on an outer surface of the damper hub and a flywheel fixed to the damper configured for transferring torque from an engine to the damper hub via the damper.

A method for forming damper hub assembly for a marine vessel propulsion unit is also provided that includes securing a disc to an inner circumferential surface of a damper hub at an engine side of the damper hub.

### BRIEF DESCRIPTION OF THE DRAWINGS

The present invention is described below by reference to the following drawings, in which:

FIG. 1 shows a cross-sectional side view of a drive assembly for a marine vessel propulsion unit according to an embodiment of the present invention;

FIG. 2 shows an enlarged cross-sectional side view of a portion of a hub assembly of the drive assembly shown in FIG. 1; and

FIGS. 3a and 3b show perspective views illustrating how a disc is inserted into the hub assembly.

### DETAILED DESCRIPTION

The present disclosure provides closed hub of a damper for a marine application. A shaft extends into the hub, but does not pass through. A disc-shaped cap is pressed into a groove machined into the hub, after which the hub is staked to prevent the cap from being dislodged. The cap limits humidity at the hub-shaft interface, and prevents grease from contaminating other parts of the transmission system.

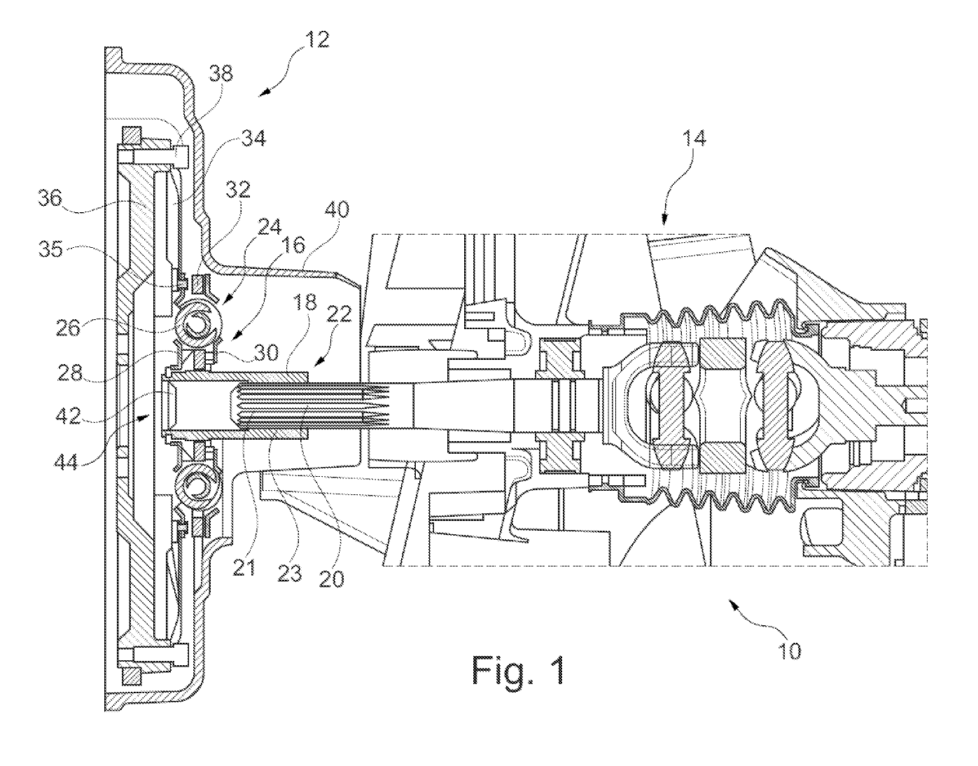

FIG. 1 shows a cross-sectional side view of a drive assembly 10 for a marine vessel propulsion unit according to an embodiment of the present invention. Drive assembly 10 includes a flywheel assembly 12 connected to a transmission 14 by a hub assembly 16. More specifically, drive assembly 10 is connected to transmission 14 by a connection between a hollow hub 18 of hub assembly 16 and an input shaft 20 of transmission 14. Input shaft 20 extends partially into hub 18 at a transmission side 22 of hub 18. Input shaft 20 includes a splined outer radial surface 21 that drivingly engages a splined inner radial surface 23 of hub 18.

Hub assembly 16 further includes a damper 24 formed by springs 26 received between two cover plates 28, 30. A flange 32 drivingly connected to hub 18, by for example splines, is provided between cover plates 28, 30. Flange 32 includes a plurality of circumferential extending spaces formed therein for receiving springs 26. Damper 24 further includes a spring plate 34 for connecting damper 24 to a flywheel 36. Spring plate 34 at a radial inner end thereof is fixed to cover plate 28 by rivets 35 and at a radial outer end is fixed to flywheel 36 by bolts 38. Flywheel assembly 12 further includes a cover 40 surrounding flywheel 36 and hub assembly 16. Flywheel 36 is configured for connection to a crankshaft of an engine. Torque from the engine is transmitted by flywheel 36 to spring plate 34, which transfers the torque to cover plates 28, 30. Cover plates 28, 30 in turn transfer the torque to springs 26, which circumferentially drive flange 32 to rotate hub 18. Hub 18, via the splined connection with input shaft 20, drives transmission 14.

A schematically shown disc 42, which acts as a cap of an engine side 44 of hub 18 is provided at engine side 44. Disc 42 may advantageously prevent grease provided at the interface of splined surfaces 21, 23 of hub 18 and input shaft 20 from flowing axially out of hub 18 during the operation of drive assembly 10. Additionally, disc 42 may limit the humidity at interface of splined surfaces 21, 23 by providing a barrier from the humidity within flywheel assembly 12 from entering axially at engine side 44 of hub 18.

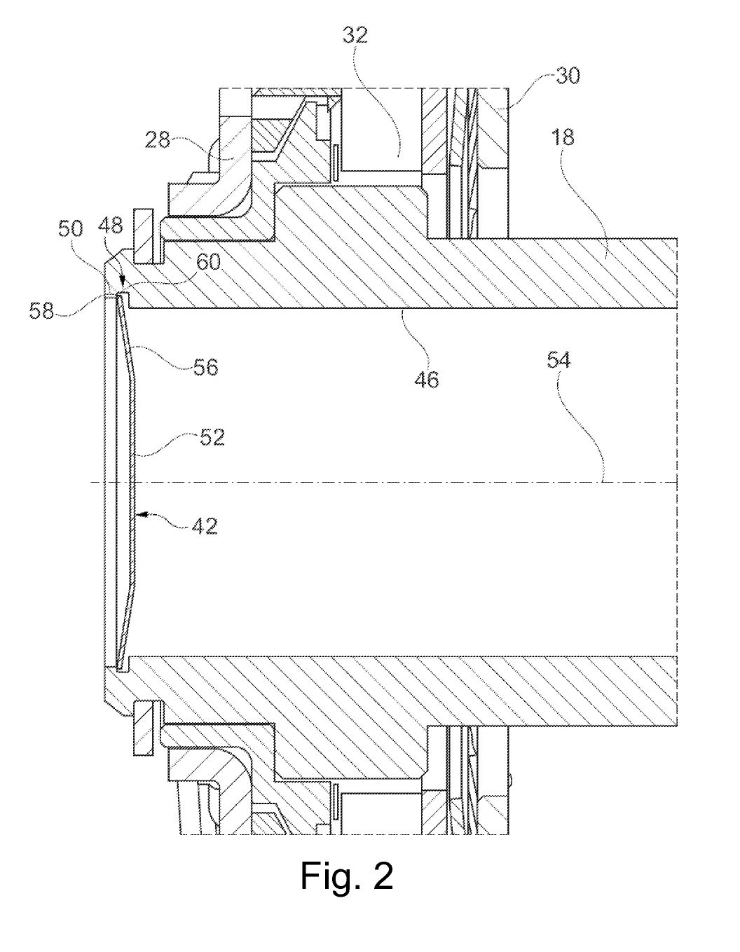

FIG. 2 shows an enlarged cross-sectional side view of a portion of hub assembly 16. As shown in FIG. 2, disc 42 is held at an inner circumferential surface 46 at an annular groove 48 formed in inner circumferential surface 46 for example by machining. A plurality of radially inwardly directed radial protrusions 50 may be formed at inner circumferential surface 46 to hold disc 42 axially in place at engine side 44 of hub 18. Disc 42 includes a center base 52 extending radially in a plane that is perpendicular to a center axis 54 of hub 18 about which damper hub assembly 16 rotates during operation. Center axis 54 is coincident with an axial center of center base 52. At an outer circumference of center base 52, disc 42 includes a radially outer radial portion 56 for engaging inner circumferential surface 46 at groove 48. In this embodiment, outer radial portion 56 is frustoconically shaped. Radially outer portion 56 extends radially away from center base 52 and, to a lesser extent, extends axially toward engine side 44 of hub 18. Radial protrusions 50 contact an axial outer edge 58 of radially outer portion 56 to secure disc 42 axially in hub 18 and groove 48 contacts an outer radial edge 60 of radially outer portion 56 to secure disc 42 radially.

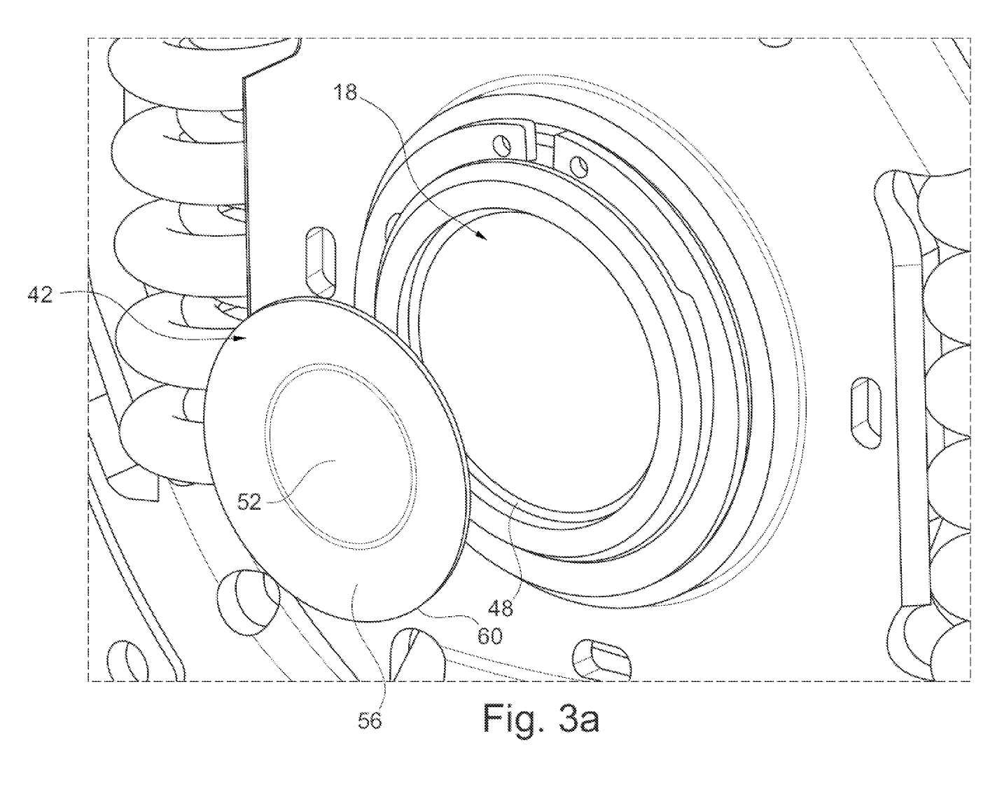

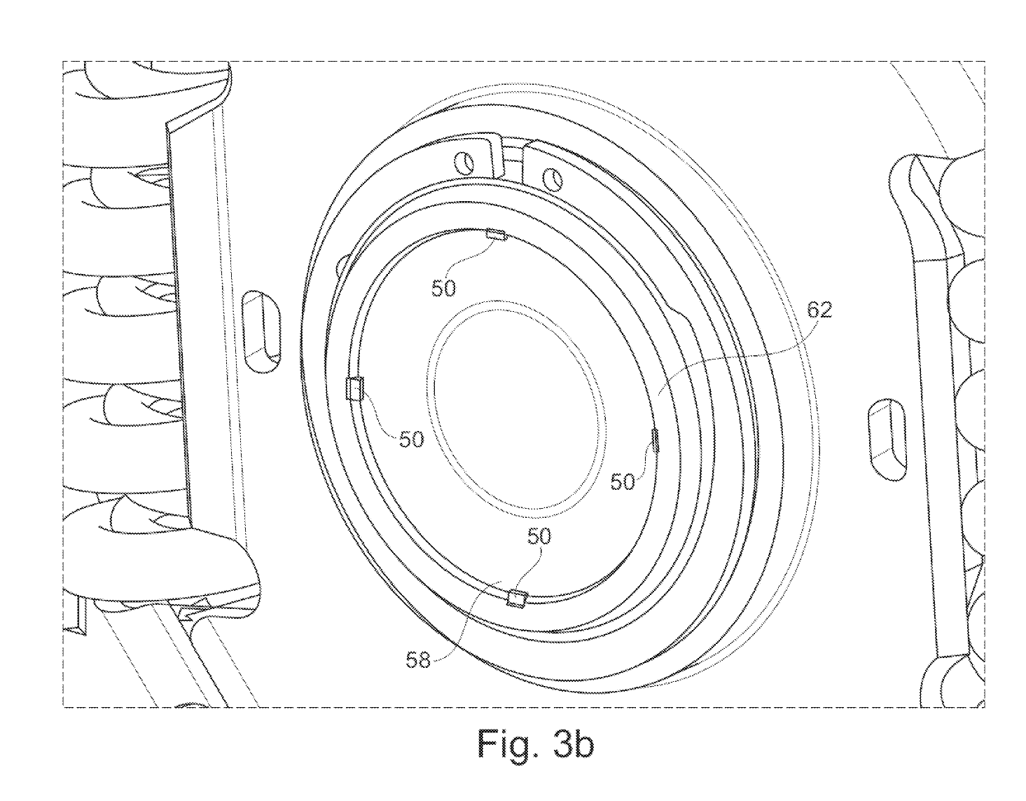

FIGS. 3a and 3b show perspective views illustrating how disc 42 is provided into hub 18. First, groove 48 is provided in inner circumferential surface 46 of hub 18. Next, disc 42 is provided in groove 48 such that outer radial edge 60 of radially outer portion 56 contact inner circumferential surface 46 at groove 48. After disc 42 is placed in groove 48, as shown in FIG. 3b, an outer axial edge 62 of hub 18 at engine side 44 is staked to form radial protrusions 50, such that protrusions 50 contact axial outer edge 58 of radially outer portion 56 to secure disc 42 axially in groove 48.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A damper hub assembly for a marine vessel propulsion unit comprising:
a damper hub having an inner circumferential surface; and
a disc held at the inner circumferential surface.

2. The damper hub as recited in claim 1 wherein the disc forms a cap at an engine side of the damper hub.

3. The damper hub assembly as recited in claim 1 wherein the damper hub includes an annular groove in the inner circumferential surface, the disc being held in the groove.

4. The damper hub assembly as recited in claim 3 wherein the damper hub includes a plurality of radially inwardly directed radial protrusions formed at the inner circumferential surface holding the disc axially in place at an engine side of the damper hub.

5. The damper hub assembly as recited in claim 1 wherein the disc includes a center base having an axial center coincident with a center axis of the damper hub about which the damper hub assembly rotates during operation.

6. The damper hub assembly as recited in claim 5 wherein the center base extends radially in a plane that is perpendicular to the center axis of the damper hub.

7. The damper hub assembly as recited in claim 5 wherein the disc further includes a radially outer portion extending radially away from the center base and, to a lesser extent, extends axially away from the center base toward an engine side of the hub.

8. The damper hub assembly as recited in claim 7 wherein the radially outer portion is frustoconically shaped.

9. The damper hub assembly as recited in claim 8 wherein an outer radial edge of the radially outer portion contacts the inner circumferential surface of the damper hub.

10. The damper hub assembly as recited in claim 8 wherein the damper hub includes a plurality of radially inwardly directed radial protrusions formed at the inner circumferential surface contacting an axial outer edge of the radially outer portion to secure the disc axially in the hub.

11. A drive assembly for a marine vessel propulsion unit comprising:
the damper hub assembly as recited in claim 1;
a damper on an outer surface of the damper hub; and
a flywheel fixed to the damper configured for transferring torque from an engine to the damper hub via the damper.

12. The drive assembly as recited in claim 11 further comprising a transmission input shaft rotationally fixed to the inner circumferential surface of the damper hub at an interface.

13. The drive assembly as recited in claim 12 wherein the disc prevents grease from the interface from flowing axially out of an engine side of the damper hub.

14. A method for forming damper hub assembly for a marine vessel propulsion unit comprising:
securing a disc to an inner circumferential surface of a damper hub at an engine side of the damper hub.

15. The method as recited in claim 14 further comprising forming a groove in the inner circumferential surface of the damper hub, the securing the disc to the inner circumferential surface including provided the disc in the groove.

16. The method as recited in claim 15 wherein the securing the disc to the inner circumferential surface includes staking an axial edge of the hub to form radially inwardly directed radial protrusions at the inner circumferential surface contacting an axial outer edge of disc to secure the disc axially in the hub.
